(19) United States
(12) Patent Application Publication
(10) Pub. No.: US 2019/0109807 A1
(43) Pub. Date: Apr. 11, 2019

(54) METHOD AND SYSTEM FOR PRESENTING INTERACTIVELY EDITABLE ELEMENTS IN A MESSAGE TO RECIPIENTS

(71) Applicant: Granite Apps Sàrl, Saint-Aubin-Sauges (CH)

(72) Inventors: Tristan Derbanne, Lausanne (CH); Charles Baur, Saint-Aubin-Sauges (CH)

(21) Appl. No.: 16/156,932

(22) Filed: Oct. 10, 2018

(30) Foreign Application Priority Data
Oct. 11, 2017 (IB) PCT/IB2017/056270

(51) Int. Cl. H04L 12/58; G06F 3/0484

(52) U.S. Cl. CPC H04L 51/14; G06F 3/04842

(57) ABSTRACT

A method for message communication to interactively determine parameters of an event, the method comprising the steps of displaying a first messaging user interface on a first terminal of an event initiator, composing a first message by the event initiator by inputting a content by an input device of the first terminal, the content of the first message related to the event, selecting a portion of the content to be designated an editable element of the first message, the selected portion of the content including a first parameter of the first message, sending the first message to a first receiver, displaying the first message at a second messaging user interface on a second terminal of the first receiver, the selected portion of the content being highlighted at the second messaging user interface, modifying the editable element of the first message by the first receiver to change the selected portion to a second parameter to create a second message, and sending the second message to the event initiator.

### CROSS REFERENCE TO RELATED APPLICATIONS

The present application claims priority to International Application No. PCT/IB2017/056270, filed on Oct. 11, 2017, the entire contents of which are incorporated herein by reference.

### FIELD OF THE INVENTION

The present invention relates generally to communications systems and applications. More specifically, a technique for sharing information among users is described, for example an instant messaging system and event organizing software.

### BACKGROUND OF THE INVENTION

Instant messaging and chatting has become a popular application for fast and reliable communication over the Internet and over type of data communications, and over telephony networks. Instant messaging programs allow users to send and receive messages to one or more users, and these messages can be displayed in order of reception. The messages are typically displayed by an instant messaging application that is operated on a terminal, for example a smart phone or a computer of each recipient, and an instant messaging or chatting server may perform various functions for the transfer, encryption, and processing of messages and chats for communication or conversation.

Software intended for implementing an instruction set in an instant messaging environment, for example but not limited to Whatsapp™, Facebook™ Messenger, SnapChat™, Skype™, Viber™, QQ Mobile™, BlackBerry™ Messenger, a telephony-based SMS or MMS service, a secured instant messaging like Threema™, Chiffry^{TM} may be generally referred to as an instant messenger (IM) or chatting application. Existing IM applications typically allow limited data exchanges such as text messages, and the including of different files, for example images, videos, audio recording. In the background art, U.S. Pat. No. 7,120,672 suggest sending a wish list having selectable items to the users. However, despite these advancements in the field of instant messaging and chatting, the sharing and modifying of additional interactive information is desired, for example for the purpose of organizing and planning events for a certain number of potential participants, with a simple and fast possibility to interact on proposed content.

### SUMMARY

According to one aspect of the present invention, a method for message communication to interactively determine parameters of an event is provided. The method preferably includes the steps of displaying a first messaging user interface on a first terminal of an event initiator, composing a first message by the event initiator by inputting a content with an input device of the first terminal, the content of the message related to the event selecting a portion of the content to be designated an editable element of the message, the selected portion of the content including a first parameter of the first message, and sending the first message to a first receiver. Moreover, the method further preferably includes the steps of displaying the first message in at a second messaging user interface on a second terminal of the first receiver, the selected portion of the first message being highlighted at the second messaging user interface, modifying the editable element of the first message by the first receiver to change the selected portion to a second parameter to create a second message; and sending the second message to the event initiator.

According to another aspect of the present invention, a method for message communication between an event initiator and a plurality of participants to interactively determine parameters of an event is provided. Preferably, the method includes the steps of displaying a plurality of messages in a message thread of a graphical user interface of a terminal of a participant, the first message displayed in the message thread having been sent by the event initiator to the plurality of participants, each message of the plurality of messages includes and displays a content that is the same for all messages, the content related to the event, and each message includes and displays a parameter of a plurality of parameters that are associated to an editable element, each one of the plurality of parameters being different from each other, and selecting one of the plurality of messages displayed in the message thread to become an editable message such that the participant of the terminal can edit the editable element to change the parameter that is displayed to a different parameter among the plurality of parameters.

According to still another aspect of the present invention, a system for message communication between an event initiator and a plurality of potential participants to an event, to interactively determine parameters of the event, is provided. Preferably, the system includes a messaging server, a terminal associated with the event initiator, and a terminal associated to each one of the plurality of participants. Moreover, preferably, the terminal of the event initiator is configured to display a first messaging user interface on a display of the terminal of the event initiator, compose a first message by the event initiator by inputting a content with an input device of the terminal, the content of the message related to the event, select a portion of the content to designate an editable element of the message, the selected portion of the content including a first parameter of the first message, and send the first message to the plurality of participants.

Moreover, preferably, a terminal associated to a participant is configured to, upon reception of the first message, display the first message in a second messaging user interface on the terminal of the participant, the selected portion of the first message being highlighted at the second messaging user interface, modify the editable element of the first message by the participant to change the selected portion to a second parameter to create a second message, and send the second message to the event initiator and the other participants of the event.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 shows a flow chart illustrating the method of sending a message with one or more editable elements to one or more recipients, by way of example, according to one aspect of the present invention;

FIG. 2 shows an exemplary communication system for implementing the method for presenting editable elements to messaging recipients, according to another aspect of the present invention;

FIGS. 3A-3D show exemplary graphical user interfaces 300 of different stage of the method from a viewpoint of the terminal of the event initiator EI, with FIG. 3A showing an example of a graphical user interface for creating a first message M1 with two editable elements EE1, EE2, with FIG. 3B showing another example of a first message M1 with a window or other graphical element for automatic processing of the editable elements EE1, EE2 of message M1, FIG. 3C showing the message thread 325 after responses in the form of messages M2, M4 have been received from recipients C2, C4, respectively, with edited or modified elements, and FIG. 3D showing a window or other graphical element for automatically creating parameters PAR of the editable elements by an automated algorithm or random selection;

FIGS. 4A-4G show exemplary graphical user interfaces 400 of different stages of the method from a viewpoint of the terminals of recipients C, with FIG. 4A showing an exemplary message window 420 that can be displayed in a message thread 425 showing received message M1 processed to show selector elements or icons SEL1, SEL2, and rating elements, icons, or scales RATE1, RATE2 associated to all the parameters PAR of the displayed editable elements DEE, FIG. 4B showing an exemplary message window 425 that can be displayed in a message thread 425 showing received message M1 processed to show DEE1, DEE2 as editable text boxes ET1, ET2, respectively, and FIG. 4C showing an exemplary message window 420 that can be displayed in a message thread 425 showing received message M1 processed to show selector elements or icons SEL1 associated to all the parameters PAR1-PAR3 of DEE1, and rating elements, icons, or scales RATE1 associated to all the parameters PAR1-PAR4 of DEE2, and a separate rating button RATE, FIGS. 4D-4G showing message threads 425 during the method where different edited messages are received from participants C, with FIG. 4G showing an example of the message thread 425 once the EI has send out a confirmation message CM with the final content to the recipients C;

FIG. 5 shows an exemplary data structure in the form of a table or a data packet for the messages M1, M2, . . . for sending and receiving the message over the network;

FIG. 6 shows another exemplary embodiment of the graphical user interface 400 and message thread 425 from a viewpoint of the recipients; and

FIG. 7A-7C shows an example were businesses as a different class of participants partake in the method for instant messaging, with FIG. 7A showing an exemplary flowchart in which businesses B participate in the instant messaging method, in the example shown two business B1, B2, to review content of the messages and make offers or other types of contributions to the messages at different times, and FIG. 7B shows an exemplary message thread 425 seen from the recipients C in which one or more businesses have made offers O related to the event E, for example in form of an offer MB1 from business B1, and a coupon MB2 from business MB2, and FIG. 7C shows a screen shot of an exemplary graphical user interface having button for adding business participants.

Herein, identical reference numerals are used, where possible, to designate identical elements that are common to the figures. Also, the images are simplified for illustration purposes and may not be depicted to scale.

### BRIEF DESCRIPTION OF THE SEVERAL EMBODIMENTS

According to one aspect of the present invention, a messaging, texting or chatting method and system is provided, permitting users of the messaging system to send messages to one or more users, for example recipients, via a private or public communication channel, to establish an interactive and easily configurable message or chat for purposes of establishing a decision in the chat feed, for example a chat between two or more users. The presented method and system can also be implemented as an add-on in an existing text messaging application.

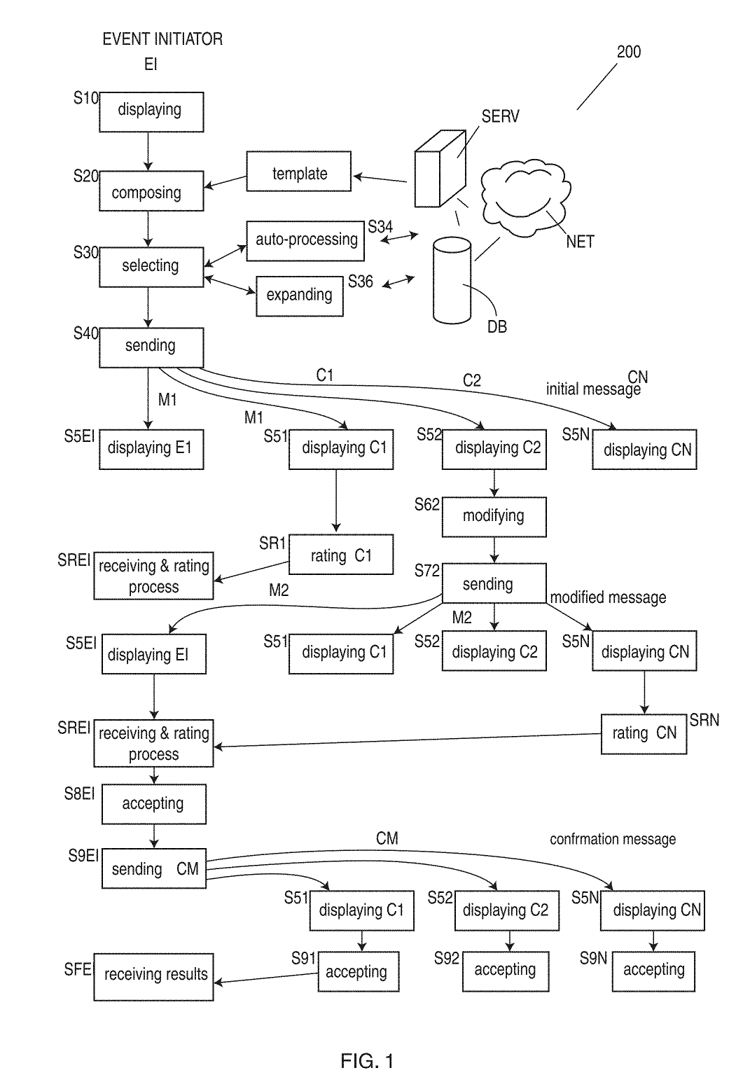

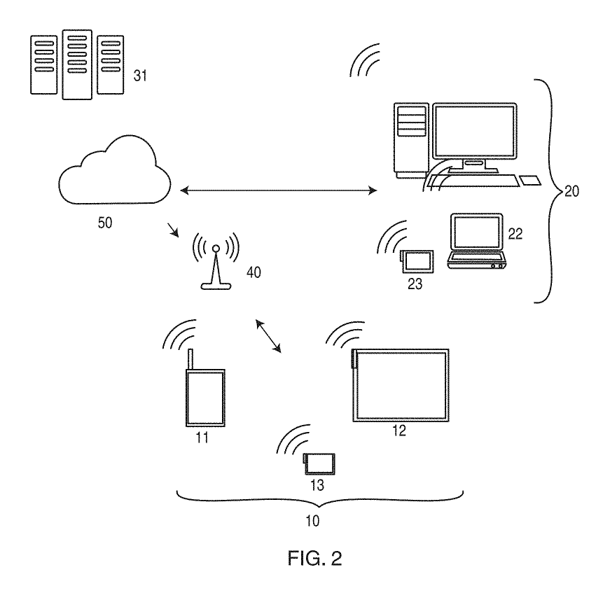

With respect to FIG. 1, a first embodiment of the method 200 is described as a schematic exemplary flowchart, that can be implemented on a computer system 100 as schematically shown in FIG. 2, having an instant messaging server 31 and several terminals 10 that can run an instant messaging application that performs the method. In this variant, the messaging method 200 is configured for a business owner or manager to receive input from existing and potential clients to define and set-up a specific service or products the business wishes offer, hereinafter an event E. The guests, clients, user, participants, or recipients C1 to CN can be part of a list of contacts, for example people who have signed up via a mailing list that can be contacted via the messaging method and system, for example via text messaging, email messaging or other type of instant messaging. The letter N stands for a positive, integer number, for example the number of participants initially chosen by the event initiator EI. For example, the event initiator EI can be a manager or owner of restaurant, hotel, or other hospitality business, and event E can be the definition of a daily menu for the restaurant, hotel, or other hospitality business.

In the exemplary system 100 shown in FIG. 2, terminals 10 are shown that are associated to one or more guests, clients, user, participants, or recipients C1 to CN, or to one or more event initiators EI. Terminals 10 can be mobile terminals or fixed terminals, including for example but not limited to tablets 12, smart phones 11, personal digital assistants 13, portable computers, laptop computers, notebooks, personal computers, Apple™ MacIntosh computers, desktops, and other types of digital data processing and display devices. These terminals 10 can be connected wirelessly or wired to a network 50, for example the internet, or a proprietary network, for example via the telephony data network 40 via a modem of terminals 10. A messaging server 31 is operably connected to network 40, and allows to receive, process, queue, and send messages M to the guests, clients, user, participants, or recipients C, event initiator EI, and other types of participants, for example different classes of participants, such as participating businesses B or view-only participants. Moreover, messaging server 31 can be operatively connected to databases, for example local databases or internet-based databases via application user interfaces (API), to access additional date, and for offline storage of messages. In a non-limiting example, the messaging server 31 is an Extensible Messaging and Presence Protocol (XMPP) and uses DSL ensures network security, server 31 facilitating instant message transfer between two or many participants C on a real-time basis.

Businesses B, and other types of participants to the messaging system 100 can use different types of terminals 20. Terminals 20 can be mobile terminals or fixed terminals, including for example but not limited to tablets 12, smart phones 11, personal digital assistants 13, portable computers, laptop computers, notebooks, personal computers, Apple™ MacIntosh™ computers, desktops, and other types of digital data processing and display devices. Both terminals 10 and 20 include a processor, memory, a display, and a user interface that permits to operate a messaging interface displayed, for example to edit and send messages, and to add or remove recipients. The processor of terminals 10 and 20 is configured to execute computer instructions of the application software, to display and operate the messaging method 200 on the terminal side, and to allow the user to operate the graphical user interface for the messaging method 200

Terminals 20 can be identical to terminals 10 but for a different configuration of the application software, and can be operated by third-party recipients, for example contributing, bidding or offering businesses, view-only participants, having a corresponding application software installed thereon, or a generic application software with the corresponding access and edit rights. Also, non-transitory computer-readable media can be provided, having computer instruction code recorded thereon, for executing the respective method steps on messaging server 31 and on terminals 10, 20.

As shown in FIG. 1, in a first step S10, the EI uses a terminal 10 that can be associated to a business, and opens and starts the messaging application, the graphical user interface thereafter being displayed on a screen of the terminal 10. Thereafter, by using the graphical user interface 100, a step S20 is performed, in which the EI composes a first message M1 having a certain content. In this variant, the content is a text message that describes an initial proposition for the daily menu made by the chef of the business. Step S20 can be manually composed by the EI, or an already saved template can be used, for example a text template that has pre-selected editable elements EE, stored locally at the terminal or accessed remotely from a database DB or server SERV via the internet or other type of network NET. Next, a step S30 is performed, in which at least one portion of the content of the message will be designated as an editable element. It is also possible that steps S20 and S30 are performed somewhat simultaneously, as the EI can designate a portion of the message as an editable element as he is writing the message content. In the context of this embodiment, the EI or other person associated with the restaurant does not want to make the main course an editable element, but wants customer feedback or input related to the appetizers and the desserts, and therefore makes this part of the content editable elements EE1, EE2. For example, the restaurant has received a certain amount of freshly caught fish, or has a house specialty that they do not want to receive customer feedback.

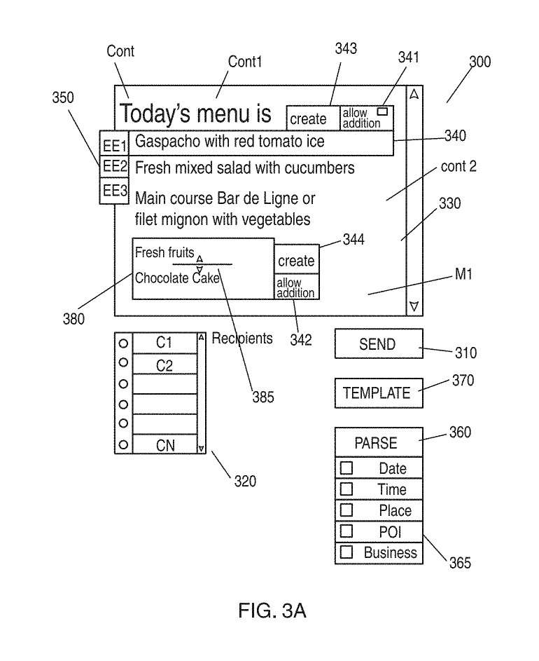

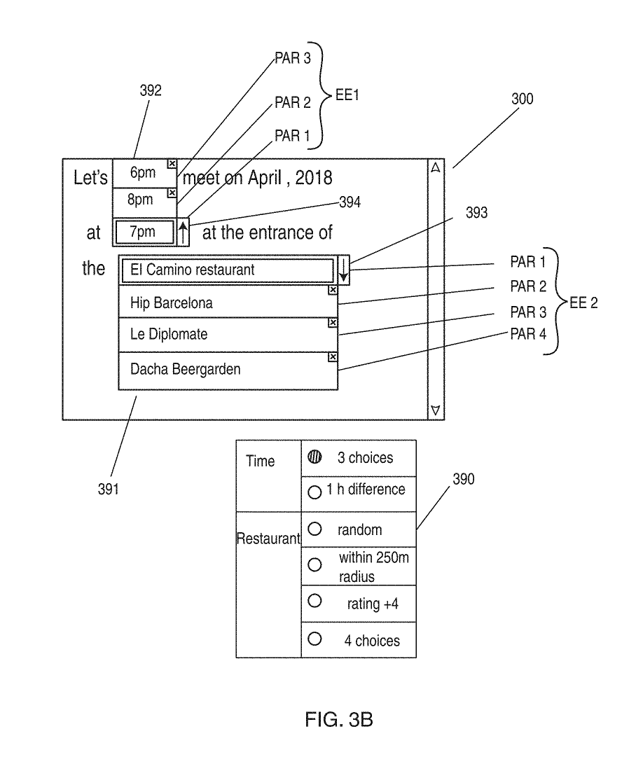

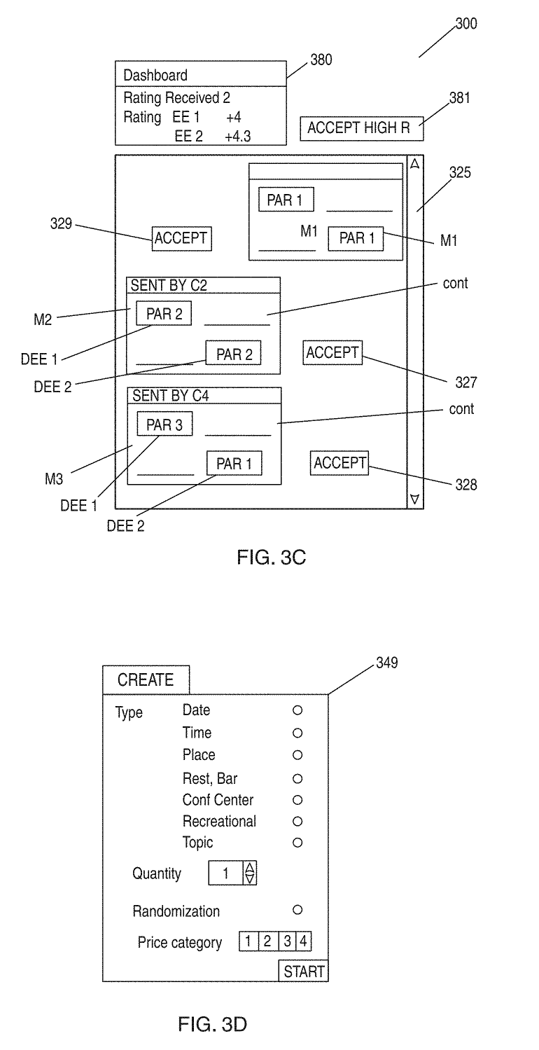

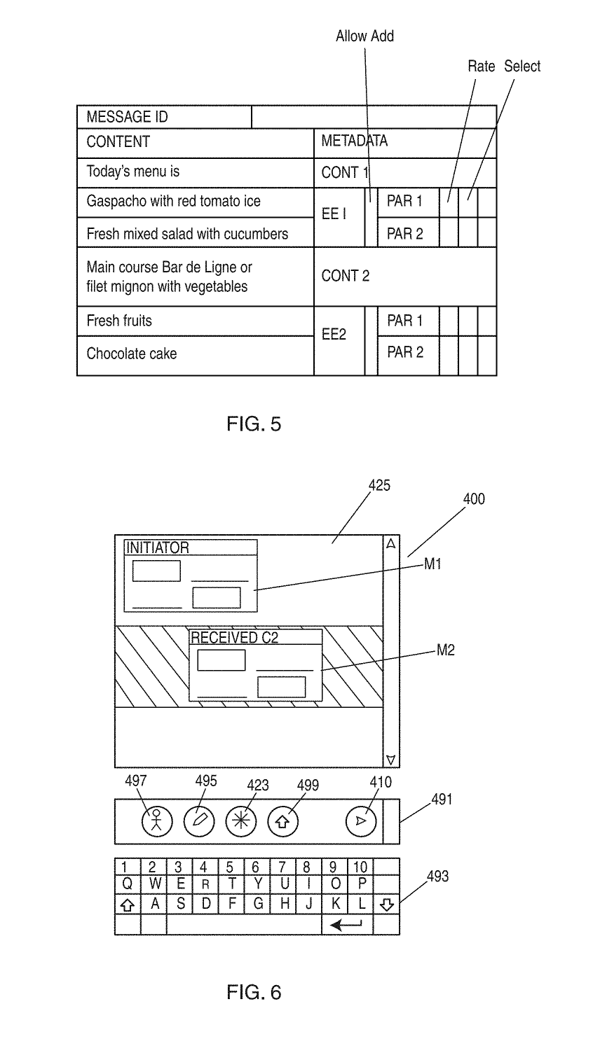

For example, as shown schematically as a data structure in FIG. 5, and a graphical user interface 300 that is schematically shown in FIG. 3A, message M1 can be composed in step S20 by the event initiator EI. The content could include a first content element CONT1 with a string of characters “Today's menu is,” this element not being an editable element, a first editable element EE1 with two parameters PAR1 and PAR2, the first parameter PAR1 being a possible choice for the appetizer, being a string of characters “Gaspacho with red tomato ice,” and the second parameter PAR2 being a second possible choice for the appetizer, being a string of characters “Fresh mixed salad with cucumbers.” Next, message M1 further includes a second content element CONT2 with a string of parameters “Main course Bar de Ligne or Filet Mignon with Vegetables,” being a non-editable element, and a second editable element EE2 with two parameters PAR1 and PAR2, the first parameter PAR1 of EE2 being a possible choice for the desert, being a string of characters “Fresh fruits,” and the second parameter PAR2 of EE2 being a second possible choice for the dessert, being a string of characters “Chocolate cake.”

The exemplary graphical user interface 300 shown in FIG. 3A, for example a graphical user interface operating and running on a smartphone, includes a text editor window 330 for manually entering the content of the first message M1, a send button 310 to send the message to one or more guests, clients, user, participants, or recipients C1, C2, . . . , CN, a recipients menu or selector 320 for selecting, adding or deleting recipients C1, C2, . . . , CN, a parse button 360 to invoke different functions for automatic processing the content and making automatic determinations on content of message M1, for example to invoke an automatic process to detect potential editable elements EE based on different categories of editable elements EE, for example but not limited to a parser, word recognition algorithm, semantic analysis algorithm, pattern recognition algorithm for text, a template button 370 that allows to select templates for the content of message M1, for example pre-composed and pre-stored messages from an internal or external storage or database DB.

Text editor window 330 can be a text editing element that is part of an instant messaging thread 325, see FIG. 3C, or a separate window with the sole purpose of creating and sending an initiation message M1 for an event E. For example, once the message M1 has been sent, the template button 370, parse button 360, and any other graphical user element that is used for configuring and editing the initial message M1 can be removed or otherwise disabled for use in the thread 325. First, the entire content of message M1 can be entered and shown as raw or formatted text with no parts thereof have been designated or otherwise selected to be made editable. With the step S30 of selecting, the user of graphical user interface 300, for example EI, will select portions of the text of content of the message, to make them editable elements, for example by highlighting, encircling, or otherwise selecting the text to be made an editable element EE, in the example shown by a text box selector 340. In another variant, this can be done by a text highlighting tool allowing the highlighting of a portion or the entire content CONT for designating the highlighted portion an editable element EE.

Moreover, it is also possible that at this stage, the event initiator EI or an automatic layout process modifies or otherwise adjust a display area size of initial message M1. In FIG. 3A, a display size of message M1 is defined by a size of rectangular box or area that forms text editor window 330. For example, initial message M1 can be displayed having a predefined, limited size that fits into a display screen of a terminal, or within a message thread, such that the message can be viewed in its entirety without a need of scrolling or zooming out. For example, by adding CONT or EE that exceeds the predefined size, or by adding CONT and EE that does not fully use the space available of the initially-displayed text box 330, the display area size of the message can be automatically fitted to the size of the CONT and EE, or can be manually adjusted to be smaller or bigger to fit the CONT and EE of the message M1. The automatic fitting by a layout algorithm can be done automatically upon sending the message M1 by the send button 310, for example to fit a certain predefined size range. Also, to avoid that the EI sends message that are too long for instant review by the participants or recipients C, unlike traditional messaging applications or e-mail applications, it is also possible that a maximal size of the display area size is limited to a predefined size, and/or also that the minimal size of the display area is limited, despite being somewhat variable in size.

Next, once a portion of the content CONT has been selected, for example the text string “Gaspacho with red tomato ice,” the selected content can be associated to a specific editable element EE1, EE2, etc., to provide for an identifier of the editable element. In the variant shown, once the portion of the content has been selected, a popup window 350 can appear that is associated with the selected content, and an identifier for the editable element can be given, for example EE1, EE2, etc. In the example, as the editable element EE1 ultimately consists of two parameters PAR1 and PAR2, it is possible to associate two or more portions of content CONT to the same editable element EE1, EE2, so that one editable element can include one or more parameters, as shown in the data structure of FIG. 5 If two or more elements are associated to the same editable element EE1, as shown in the example where “Gaspacho with red tomato ice” and “Fresh mixed salad with cucumbers” will be selected to be part of the same editable element EE1 by using popup window 350, “Gaspacho with red tomato ice” will be associated to be the first parameter PAR1 and “Fresh mixed salad with cucumbers” will be associated to be the second parameter PAR2 of the editable element EE1.

In a variant, as shown in FIG. 3A, it is possible to select multiple portions of the content text CONT together with selector tool 340, for example as shown for the first and second parameters PAR1, PAR2 for editable element EE2 with selector tool 380, and thereafter, split up the selected content to determine the different parameters PAR1, PAR2 for the same editable element EE2, being “Fresh fruit” and “Chocolate cake,” for example by using a second selector tool within the first selector tool 340, or placing divider marks 385 on the graphical user interface 300 to split up the selected editable element EE1 into two or more parameters PAR1, PAR2. Moreover, it is also possible that an empty text passage or empty box is selected to be the editable element EE, or that the entire content CONT is part of one editable element EE. It is also possible that the message M1 only is made of one editable element EE1 having only one parameter PAR1.

In a variant of step S30 of selecting, the selecting of the editable elements EE is can be done automatically with an additional optional step S34 of automatic processing, instead of the manual editing with selectors 340, 380, 385. For example, once the message M1 and its content is composed by step S20, either by manual entry or by selecting a template, the parse or automatic processing button 360 can be used to search for text portions that can be made editable. For example but not limited to dates, times, date ranges, time ranges, geographic locations, businesses, price, price range, places or points of interest, can be searched and designated to be automatically made an editable element EE, for example by selecting different criteria for automatic designation as editable element EE, with selector tool 365 that pops up when the parse button 360 is selected. This can be done by an automatic process, for example but not limited to a parser, word recognition algorithm, semantic analysis algorithm, pattern recognition algorithm for text.

For example, as shown in the example of FIG. 3B from a viewpoint of the terminal of the event initiator ET, in this case the EI being a person who wants to meet with some friends or colleagues, event E being a social lunch, dinner, or happy hour, or other type of social event with beverages and/or food. Message M1 is shown to have a specific content with the purpose to initiate the event by contacting a list of potential participants, and EI can compose a message M1 with the raw, unselected content “Let's all meet on April 1, 2018 at 7 pm at the entrance of the El Camino Restaurant.” Thereafter, in a step S34, the parse button 360 is selected, where “date,” “time,” and “business,” are selected as criteria for automatic designation as editable elements. Next, after the parsing is started, the algorithm performs an automatic processing to detect these elements, and returns a message M1 with “April 1, 2018” being a first editable element EE1, “7 pm” a second editable element EE2, and “El Camino Restaurant” a third editable element EE3.

Once at least some editable elements have been selected for message M1, editable element configuration buttons or icons 341, 342 can be displayed that are associated to a specific editable element EE1, EE2, respectively, to provide for additional configurations and settings for the message M1 once received by participants C1, . . . , CN. For example, participants C1, . . . , CN can be allowed or denied the participants to add additional parameters PAR to the respective editable element EE. In case EI does not want any additional suggestions from the participants C1, . . . , CN other than his own, and the choice of parameters for the respective individual editable element EE is fixed, he can choose not to select this option, by not selecting editable element configuration buttons or icons 341, 342.

Moreover, in a variant, once the editable elements have been created, either empty boxes or a text element, it is possible to automatically create parameters by an algorithm by selecting one of the create buttons 343, 344 associated to the editable elements EE1, EE2, respectively, as a variant of the step of automatic processing S34. The algorithm can be implemented in the application software running on the terminal 10 of EI, or as an application that is operated on the messaging server 31. Upon selecting one of the create buttons 343, 344, a pop-up menu or roll-down menu 349 can appear, to automatically create a certain number of parameters for the selected EE, exemplarily shown in FIG. 3D. For example, the EI can choose the type of parameter that needs to be created, selecting from the list consisting of date, time, place, restaurant or bar, conference center, facility, venue, recreational business (carting, darts, bowling, amusement park, etc.), or topic, point-of-interest, chose the quantity of parameters that need to be generated, chooses where the choices should be a randomized selection from a list of possible choices, and can choose the price category. Upon making choices, the application software can generate per algorithm the desired number of parameters PAR, by taking several information data into account. For example, depending on a personal or professional profile of the selected participants C1, . . . , CN, that has been made available to the EI, and a geographic location of the participants C1, . . . , CN, calendar and availability information of the participants C1, . . . , CN, preferences to food, beverages, age of participants C1, . . . , CN, a date, time, and restaurant choice can be generated. Once a list of restaurants has been generated, a random selection can be presented as parameters PAR. Based on information of the participants C1, . . . , CN, a selection can be made per algorithm to fit the most participants possible.

Also, with buttons 343, 344 a parameter restriction can be created that is specific to the editable element EE1, EE2, respectively. For example, for a parameter of the type “time,” the restriction can be a time range, for the parameter of the type “date,” the restriction can be a date range, a period, a week-end, a week, a month, for a parameter of the type location the restriction can be a specific geographic area. Also, it is possible to create only one parameter PAR1 for and editable element EE1 that is manifested as an editable text box ET1, but a list of possible options have been affixed to the EE1 as a parameter restriction, for example a list of restaurants that are considered acceptable by the EI, a list of flight destinations that are accessible by an airline with a direct flight, a list of possible answers to a question. This restricts the possible choices to a list of elements for editing an editable element EE by the editable text box ET. As shown in FIG. 3B, the parameter restrictions, for each editable element EE, can be set by a settings window 390.

Before sending the message M1 in a step S40, the message M1 can be manually edited to add or remove editable elements to editable elements EE1, EE2, EE3. For example, the EI may want to keep the date fixed, and removes the designation of “April 1, 2018” as being a parameter PAR1 and an editable element EEL In this example, each editable element EE1, EE2, and EE3 has only one parameter PAR1 being “April 1, 2018,” PAR2 being “7 pm”, PAR3 being “El Camino Restaurant,” each. The automatic processing step S34 can be performed by an parsing and detection algorithm that is installed locally at the terminal 10, or can also refer to third party applications that are accessible over a web interface via the internet NET.

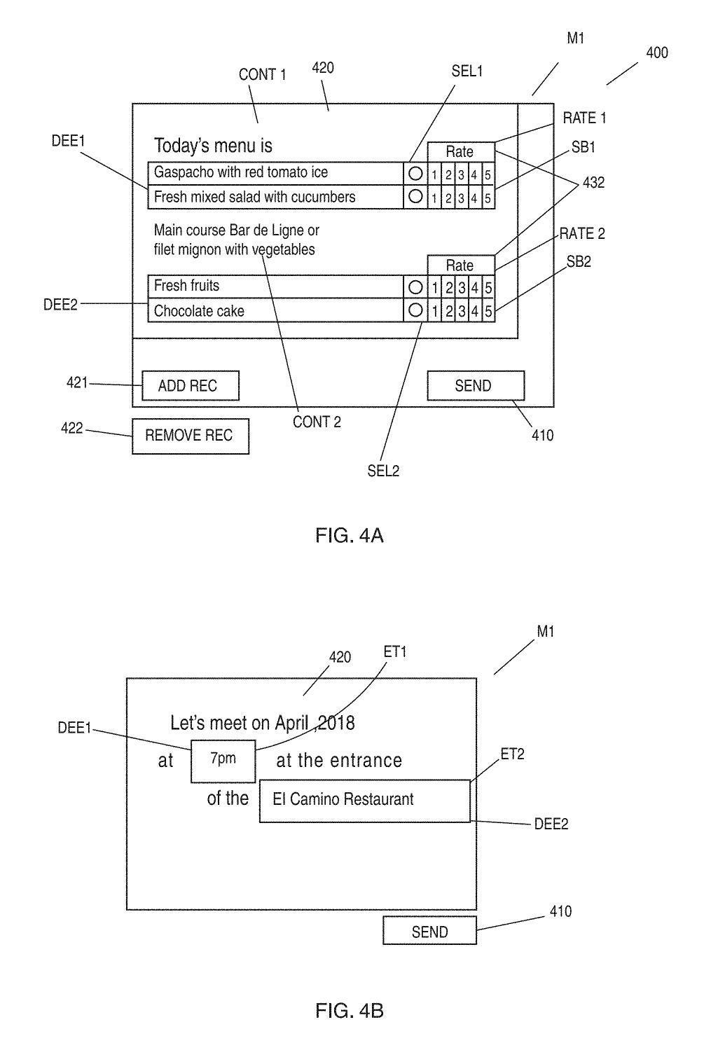

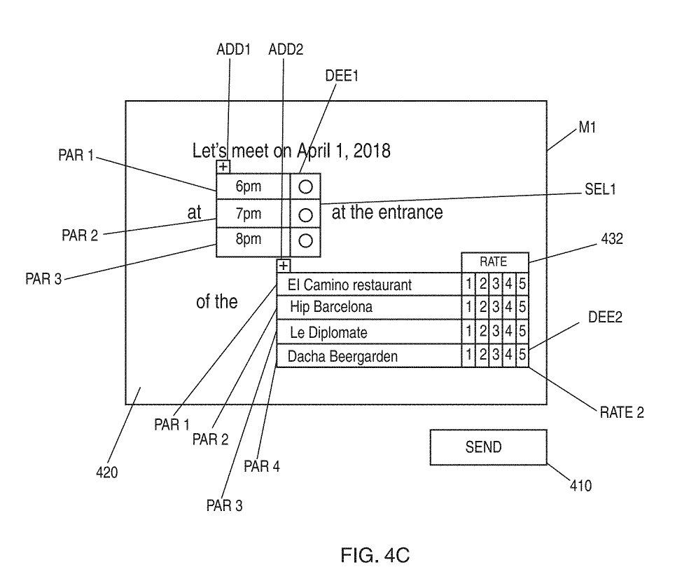

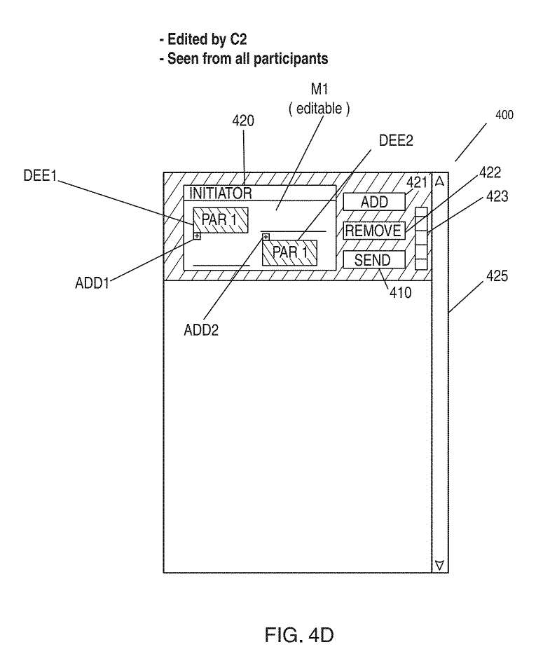

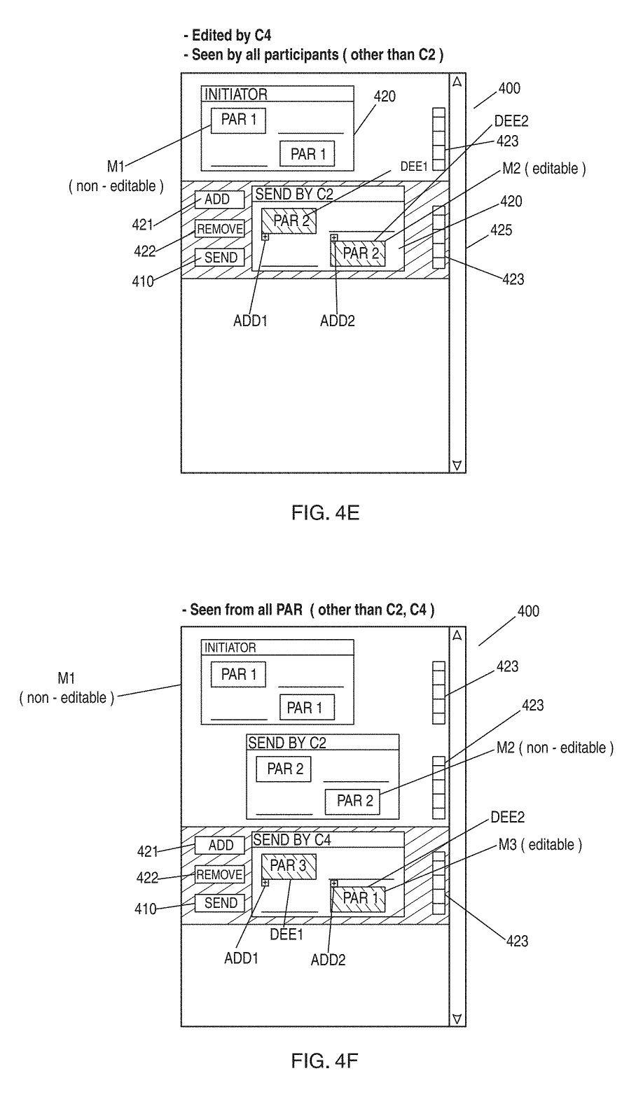

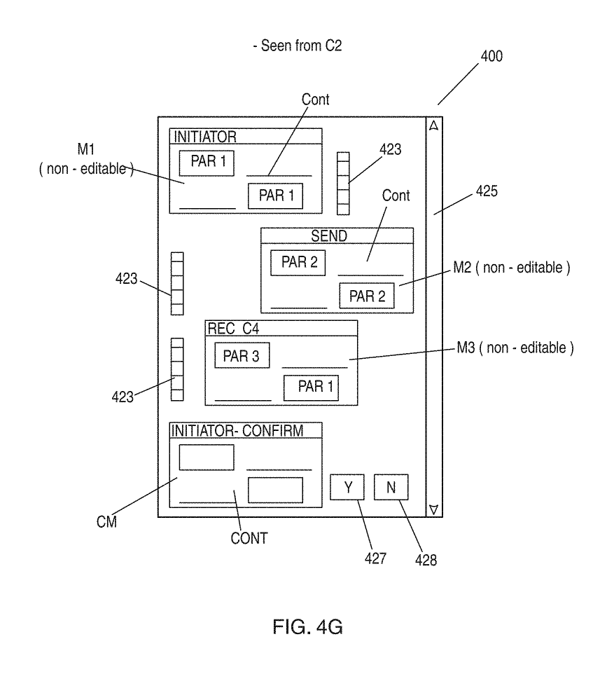

In a variant, once the message M1 is composed, and the editable elements EE have been determined, it is possible to expand the editable elements to include one or more parameters PAR in a step S36 of expanding. For example, this allows to expand the number of parameters to add additional parameters that are different in value, but still related to the already existing parameter of the editable element EE, for example being the same class of parameters. For example, with the example shown in FIG. 4B, “7 pm” a message content has been designated as the only parameter PAR1 of the editable element EE1, and “El Camino Restaurant” is designated as the only parameter PAR1 of editable element EE2. PAR1 of EE1 is classified as a time, and PAR1 of EE2 is classified as a restaurant or more broadly as hospitality business or venue where you can have a meal. The automatic processing step S34 could have determined the classification of EE1 and EE2, or could have been done manually by the EI. Then, next to each highlighted area of the two editable elements EE1 and EE2 of the graphical user interface 300, and expand button 393, 394 can appear that can be clicked or otherwise selected by the user, as shown in FIG. 3B. Once the user selects the expand button 393, 394, for the editable element EE1, EE2 of choice, a pop-up window will appear with additional proposed parameters in the same category of the respective editable element that can be added to the already existing parameters PAR1.

These additional proposed parameters can be automatically generated based on a predetermined setting that can be accessed by a settings window 390 as shown in FIG. 3B. These settings can be part of the user profile, for example the EI profile, and can be stored locally or stored remotely at a server SERV. For example, for an editable element EE1 that is classified as “time,” different times can be proposed as the automatically generated values, and the settings for generating these different times can include a total number of time choices that can be proposed, in the variant shown three (3), the difference between the different proposed times, in the variant shown one hour (1 h). Also, for an editable element EE2 that is classified as “restaurant,” the additional parameters that are automatically generated as values can include all restaurants within a certain radius of the restaurant defined in PAR1 of EE2, within a certain radius of a current location of the EI, within a certain chosen geographic area or neighborhood, for example a specific ZIP code, the total number of proposed restaurants as parameters in EE2, a random selection of restaurants, restaurants having a rating above a certain threshold. It is also possible that the step S36 of expanding uses internet data resources, for example Yelp™ reviews for the ratings, Google Maps for localizing businesses within a certain area and opening hours that correspond to the selected time, to avoid an additional proposed parameter that has opening hours that are outside of the proposed time and date. In this respect, step S36 applies a filter to a certain amount of predetermined criteria, to first find a list of potential additional proposed parameters, and if necessary, limits the proposed parameters to the chosen amount.

The additional proposed parameters generated by step S36 of expanding can be displayed and reviewed by the user, for example in windows 392 and 391 that are associated with the respective editable element EE1, EE2, for example showing a total of three proposed times with PAR1, PAR2, PAR3 for EE1, and a total of four proposed restaurants as PAR1, PAR2, PAR3, PAR4. With a delete icon, it is possible for the user to delete individual proposals of restaurants as parameters PAR. In case the restaurants have underlying websites, it is also possible to attach a hyperlink as metadata to the parameters PAR1 to PAR4, and make the display of the restaurant name a clickable link.

After EI has composed a message and determined the editable elements EE and the parameters PAR of the editable elements, with at least one of step S30, S34, and S36 the EI can send the message M1 to one or more recipients, in the variant shown recipients C1, C2, . . . , CN, by pressing the send button 310, in a step S40. The recipients C1, C2, . . . , CN are contacts that have been selected or otherwise chosen by the EI, for example but not limited to from a customer contact list, list of friends, members of an interest group, habitants of a town, city, village, or neighborhood. This allows to multicast the message to one or more recipients with the underlying instant messaging infrastructure, for example via the instant messaging server 31. Next, the message M1 is received by the recipients C1, C2, . . . , CN, and they can be alerted of the arrival of a new message at their terminal 10.

Once the recipients open their message application for the instant messaging method 200, the message M1 can be displayed in the message thread 425 of graphical user interface 400 in steps S51, S52, . . . , SSN, for recipients C1, C2, . . . , CN, respectively, as shown in FIG. 4D. Other examples are shown in FIG. 4B and 4C, showing text box 420 without message thread 425, in the context of the event E related to the restaurant meeting. In the respective graphical user interface 400, the message text is displayed in window or text box 420, showing the content of the message, with a first content CONT1 and a second content CONT2 as non-editable text or other non-editable content, and with the displayed editable elements DEE1 and DEE2, that correspond to editable elements EE1 and EE2, respectively, as highlighted text boxes DEE1, DEE2.

It is noted that throughout the message thread 425 of the recipients, in the variant shown, the content CONT1, CONT2 of any previous message M1, M2, M3, etc. is not modifiable anymore, other than the content of the DEE. Therefore, unlike the EI, the graphical user interface 400 displayed at the terminal 10 of the recipients C1, . . . , CN is configured such that the recipients C1, . . . , CN will be given a limited opportunity to modify message M1 to create a modified message M2, in which they can only edit or modify those portions of the message that were intended for modification by EI, as editable elements EE, and cannot change the fixed content CONT1, CONT2. Also, the modification of the DEE can be subject to parameter restrictions that were set by the EI. In terms of the portions that can be edited by the recipients C1, . . . , CN, the displayed editable elements DEE1, DEE2, highlighted in way that the recipients can see and identify them, to change editable elements EE1, EE2. The highlighting of the DEE can be done by choosing a different font, a bold font, cursive font, different colors, text box boundary, as exemplary shown in FIGS. 4B-4C, different shadings, blinking content, animated content, animated icons, presence of emoji, animated emoji, underlined content, and a combination thereof. Generally speaking, DEE can be highlighted such that they visually distinguish from the not-editable content CONT of the message, and can easily be identified by a user.

As shown in FIG. 4C, in the case where the editable element EE has two or more parameters PAR, the graphical user interface 400 with text window 420, including displayed editable elements DEE1, DEE2, that can be configured to show all the parameters PAR1 and PAR2 for both EE1 and EE2 simultaneously, to facilitate to the participants to make a choice or a rating, or both. For example, each parameter PAR 1, PAR2 can be displayed with graphical elements including user-selectable selector icon SEL1, SEL2 associated with it, and a user-selectable rating selector icon SB1 and SB2, respectively. This allows the recipients or users C1, C2, . . . , CN to read the text of the displayed editable element DEE1, DEE2, and either select one of the parameters PAR1, PAR2 with the selector icon SEL1, SEL2, or give a rating to the parameters PAR1, PAR2 with rating icon RATE1, RATE2, or both, via the graphical user interface of his terminal 10. Once the at least one of the selector SEL1, SEL2, rating RATE1, RATE2 has been done, it can be highlighted for feedback to the respective user, and he can change his choice by using the graphical elements, before sending the modified message M2.

In variant, in the example where the editable elements EE1, EE2 have only one parameter PAR1 associated to each element, as shown in the graphical user interface 400 of FIG. 4B from a viewpoint of the recipient C, the text window 420 of the graphical user interface 400 can be configured to display the displayed editable elements DEE1, DEE2 that have editable text boxes ET1, ET2. For example, once the message M1 is received and displayed in step S51-S5N, S5E, and no choice between different parameters PAR of an editable element EE is possible, no relative rating between parameters PAR can be made. In this case, the recipients can freely edit the editable elements EE1, EE2 via the editable text boxes ET1, ET2 for DEE1, DEE2, respectively, for example to send back a suggested time and/or locations of their choice, and send back the modified text elements with send button, for example with step S62, S72. This can also be the case when the parameter PAR of the editable element EE is an empty or blank box or string, so that the recipients or users C can enter their own information by an editable text box ET displayed in a DEE. However, it is possible that for at least one of the DEE1, DEE2 is still associated with a rating button RATE1, and that the text element cannot be changed, but merely rated by pressing or otherwise actuating rating button 432.

In another variant, as shown with the graphical user interface 400 from the viewpoint of the recipients, in FIG. 4C, it is possible that one editable element EE1 is displayed as DEE1 with a selection option SEL1, and no rating option, and the other editable element EE2 is displayed as DEE2 with only the rating option with RATE2 and a rate button 432, such that the parameters PAR1 to PAR4 of editable element EE2 cannot be directly selected, but only rated. Either the recipient can make his selections and ratings, and send the message back as modified message M2 to EI and the other participants, or can only make a rating of PAR1 to PAR4 of editable element EE2, for example by rating all of some of PAR1 to PAR4, and send back an anonymous rating with a message to EI by pressing rating button 432, as exemplified by step SR1, SRN in FIG. 1 of a rating message send be participants C1 and CN at different times.

Also, a send button 410 is presented, or other type of user-operable graphical interface element that allows sending a modified message in a step S72 by the recipients, and buttons 421, 422 that allow the user to add or remove recipients. For example, as represented in the flowchart of FIG. 1, using recipient C2 exemplarily as the first recipient to respond to message M1 from EI, in step S62, recipient C2 has modified the message M1 with the displayed editable elements DEE1, DEE2, by selecting his choices with SEL1, SEL2, and optionally giving his rating with rating icons RATE1, RATE2. This creates a new modified message M2. He then presses the send button 410 that will return the message as the new modified message M2 to all the recipients C1, . . . , CN, including the EI. It is noted that other than the interaction with the displayed editable elements DEE1, DEE2, by selecting at least one of SEL1 and SEL2, and/or the rating RATE1, RATE2 to rate individual parameters PAR, none of the original message M1 is editable. This means that the application software is configured that, upon reception and display of a message M1 from the EI, the message M1 is displayed as exemplarily shown in FIG. 4A to 4D to have only these limited choices of editing. Once edited, a new message M2 is created, in the variant shown a message M2, that can be sent back to some or all the recipients C1, . . . , CN, and the EI, see step S72. While some recipients can be removed or added with buttons 421, 422, the application software can be configured such that the message has to be sent to the EI, and that the EI cannot be removed as a recipient. Also, it is possible that only once a recipient has actually modified an initial message M1, or a following message, that he is able to sent with step S72 a modified message. For example, send button 410 may not show up or is disabled until a modification of the prior message has been done by the recipient C.

Moreover, once the message M1 has been sent with one or more editable elements EE and themselves having one or more parameters PAR, it is possible that the participants can add additional parameters APR not contemplated by the EI, if the EI allowed these with allow addition buttons 341, 342, as part of the step of modifying S62. As shown in FIG. 5, the data structure will contain information whether the EI had allowed for additions to the editable elements or not. For example, the DEE1 and DEE2 can be associated with an ADD1 and ADD2 button or icon respectively, where they can add their own choice of parameters. In the example shown in FIG. 4C, it is possible for recipient C to click or otherwise select or activate the ADD1 button, for example to add an editable text element ET1 that can be filled by the respective user, for example to add a time “6:30 pm” adding this time as PAR4 to DEE1, or can activate the ADD2 button, for example to add an editable text element ET2 that can be filled to add another restaurant based on the choice of the respective recipient, for example “The Standard,” adding another restaurant as PARS for DEE2. In another variant, it is possible that a buttons ADD1, ADD2 can add a random choice for the new parameter, by using a randomizing algorithm. It is also possible that added parameter by ADD1, ADD2 be restricted to a specific category, a specific range, a specific period of time, specific group of elements, specific classification, so that the participants cannot just simply add a nonsensical or fictitious new parameter PAR to the DEE. For example, the time range can be restricted to a certain time period, a date can be restricted to a date range, a location can be restricted to a geographic area or an area that takes into account the present position of all the participants C1, . . . , CN, such that all the participants C1, . . . , CN are able to be at the venue or location in a predetermined amount of time, by receiving their GPS position of their terminal 10, a business can be restricted to a type of business, specific rating, or opening hours. A commercial offer or request can be limited to a specific cost or price, or cost or price range. This can be set by the EI with a settings window, for example like settings window 390 shown in FIG. 3B that allows to set parameters and restrictions for the initial message M1.

In a variant, as shown with step SR1, instead of modifying the message M1 and sending back a new modified message M2 as described above, it is possible that a recipient only participates in the rating, without sending back a message, but instead sends a rating message or data packet to EI, without informing any of the other participants, with the exemplary steps SR1, SRN of FIG. 1. This can be done by the user selecting a rating on the rating scale shown by graphical elements RATE1, RATE2, and then sending the rate by button 432 to EI, or by rating a message by itself as a whole, with rating scale 423, without ever sending a modified message M2, M3, . . . etc. For example, it is possible that recipient C1 selects a rating with graphical elements RATE1, RATE2 for some or all of the parameters PAR1, PAR2 of the editable elements EE1, EE2, respectively, and subsequently, this rating is send after pressing or otherwise actuating the rate button 432 as a message to the EI, so that the EI gets a rating feedback for parameters PAR1, PAR2 that he initially chose for message M1. This allows for an anonymous rating of the parameters, in the example shown, the other recipients C2, . . . , CN cannot see any rating made by C1. In a step SREI, the EI can receive such rating messages, and dashboard 380 at graphical user interface 300 of EI can be updated to reflect the ratings, and show the number of ratings received, such that the EI has an overview on the feedback on his message M1 (FIG. 1H).

Next, after a modified message M2 has been sent by one or more of the participants C1, . . . , CN, with step S72, in the example shown participant C2 the message M2 can be displayed on the graphical user interfaces 400 of all the terminals of recipients C1, C2, . . . , CN, and on the graphical user interface 300 of the terminal of the EI, with displaying steps S51, S52, . . . , SSN, for the participants or recipients C1, C2, . . . , CN, and with step S5EI of the EI. For example, a graphical user interface 400 of the message thread 425 is shown from the viewpoint of recipients C1, C2, . . . , CN, in FIGS. 4D, 4E, 4F, and 4G, and as shown in FIG. 3C, graphical user interface 300 from the viewpoints of the EI is shown, corresponding to the same time moment of FIG. 4F, where the messages can be displayed in a timely order starting with the first message M1 that was composed and sent by EI himself in a message thread 325. As message thread 325 exceeds the size of the screen or a display area, the message thread can be made scrollable. Next, the edited messages M2, M3, etc. received from different recipients C2, C4, respectively are displayed in the thread 325 in the timely order, with the editable elements DEE1, DEE2 showing the parameters PAR as edited and sent by the respective recipient, in the example shown recipient C2 that sent message M2 first, and recipient C4 that sent message M3 second, with their respective choices and ratings of parameters, see FIGS. 3C, 4E, and 4F. In the variant shown, only the last received message is editable by recipient, and once a new message is created and received, all previous messages are made non-editable on graphical user interface 400. However, it is possible that the recipient can choose himself wish message of the message thread can be made an editable-message. Also, add, remove, and send buttons 421, 422, 410 can be moved to be associated to the last message, or associated to another message of the message thread that has been chosen by the recipient to be the editable message. In addition, the last message, or another message M that has been made editable by the user, can be highlighted for bringing the focus to the editable message, for example by a background shading around the editable message M3 having a different color or shading, as shown in FIG. 4E, or having an indicator icon pointing to the editable message M3, an area around editable message M3 in a different color or shading, an area of the message having a different color or shading, a frame around message being thicker that a frame around the non-editable messages, a blinking frame, blinking message area, or other graphical ways to highlight the message, as explained with respect to the highlighting of the displayed editable elements, or other ways to graphically distinguish the editable message from all the other non-editable messages.

From a viewpoint of the EI, as shown in FIG. 3C, associated to each message M2, M3 received, graphical user interface 300 can display an accept button 327, 328 that can be selected by the EI at any time to end the conversation in the instant messaging and send a confirmation message CM to all recipients C, for example in a step of choosing and accepting a message M as the final message S8EI, and a step of sending the message S9EI. This gives the EI the power to lock up specific parameters of the event EE. These steps can be performed as one step upon touching or otherwise activating the accept button 327, 328, 329. Also, preferably upon sending a first message M1 to the participants C and thereby initiating a discussion related to event E, a dashboard 380 can be displayed associated to message thread 325 on graphical user interface 300, including general and statistic information related to event E, for example the ratings for individual messages M that have been sent by recipients C, the ratings for individual parameters PAR of different editable elements EE of the messages M, number of ratings received, general comments sent. For example, at any time, EI can receive rating messages that are sent by recipients C1, . . . , CN via buttons or icons 423, 432, RATE1, RATE2, and update the dashboard 380 to show the results and statistics related to the ratings. Moreover, instead of accepting any of the content of message M1, M2, or M3 with accept buttons 329, 327, 328, a button 381 can be displayed, or other user-operable graphical element, that can be selected by EI to automatically accept the highest rated message as conformation message CM, or a message composed of the highest rated parameters PAR of the one or more editable elements EE as the CM. By choosing this option, the EI does not need to review any of the messages received.

Another aspect of the method is the use of a timer that limits the discussion time for the specific event E to a specific time period. It is possible that upon sending a message M1, a timer is started counting down a specific time duration. The timer can be used to keep open a time window during which recipients C1, . . . , CN can contribute to the discussion in the message thread 325, 425, and after the time duration is revolved, the contributions are blocked, and no more messages M2, M3., . . . can be sent. Thereafter, the EI can review all messages and the dashboard, and send a CM later, upon making a decision and careful review. Instead of the EI making the final choice and content of the CM, it is possible that after the time duration is revolved, data on the messages M and the editable parameters EE that is used for display at the dashboard 380 is analyzed, to send an automatically composed confirmation message CM.

With the accept buttons 327, 328, at any time after receiving the messages M2, M3, the EI can accept any one of the edited messages M2, M3 as the final proposal in the accepting step S9E1, but can also simply accept his own first composed message M1 with button 329, and a confirmation message CM can thereafter be automatically sent to all recipients. In such case, the EI acts as the master that has the final word on the program of the event he initiated, and once he sends out the CM, no more editing and modifying of the message is possible. It is also possible that an accept button 328 is shown that is always associated to the last displayed message, so that the EI can simply choose the last received message, in the example shown message M3 from recipient C4, to accept the latest choice of parameters PAR for the editable elements EE. Also, each message M2, M3 is labelled such that the EI can identify who was the creator and sender of the respective message M2, M3. In FIGS. 3C, from the viewpoint of the EI, the first initiating message M1 from EI is shown to be on the right side, while all the messages received from the recipients C1, C2, . . . , CN that are participating in the feedback to the initial message M1 with the editable elements EE are shown on the left side arranged in a different column, and are associated with an accept button 327, 328.

As discussed above, four (4) different graphical user interfaces 400 are shown of a messaging thread 425 in FIGS. 4D-4G, viewed from the recipient side. The first message M1 has been received an initiates the conversation and feedback related to the event, message M1 arranged at the left side at a position that will be associated to messages from the EI, for example at a first left-side aligned column. Message M1 is shown with a fixed, non-editable content CONT, and with displayed editable elements DEE1, DEE2, currently configured to show parameters PAR1, PAR1, and the graphical elements ADD1, ADD2 to add additional parameters. Also, associated to the editable first message M1, an add button 421 for adding recipients, a remove button 422 for removing recipients, and a send button 410 for sending off a new modified or edited message M2 is shown. Preferably, send button 410 is only displayed once the respective recipient C1, CN has edited at least one of the displayed editable elements DEE1, DEE2. Moreover, associated to message M1, a rate button 423 is shown that allows to rate the message M1 as a whole, without rating individual parameters of the editable elements. As the rating can be done at any time, the rate button 423 can remain even if new messages are coming in.

Next, in the example shown, recipient C2 modified displayed editable elements DEE1, DEE2, either by editing the text to make a different parameter, making one or more selections of the parameters, rating them, or adding a new parameter, or a combination thereof, as shown with respect to FIGS. 4A to 4C, a step S62 and thereafter sends edited message M2 to the recipients and the event initiator EI, in a step S72. While the recipient C2 can remove some of the other recipients with button 422, he cannot remove the event initiator EI from not receiving the edited message M2.

In the example shown of FIGS. 4D to 4G, recipient C2 has changed the parameters from both DEE1 and DEE2 to PAR2. For example, this can be a change of time of the meeting, a change in venue or location of the meeting (FIGS. 4B-C), a change a restaurant menu item (FIG. 4A), a change of a response to an answer where the event E is an academic test of feedback questionnaire for a query or poll. Thereafter, edited message M2 is shown in message thread 425 of all participants and the message thread 325 of the EI. Also, message M1 remains displayed with the original settings, showing PAR1 and PAR1 for DEE1 and DEE2, respectively, but cannot be edited anymore. This allows to keep a overviewable history of the messaging in the threads 325, 425. After C2 sends the message M2 with button 410 in step S72, editable message M2 is now shown below non-editable message M1 with a fixed, non-editable content CONT, and with displayed editable elements DEE1, DEE2 showing parameters PAR2, PAR2 chosen by recipient C2, and the graphical elements ADD1, ADD2 to add additional parameters. Also, buttons 410, 421, 422 are removed or otherwise dissociated with non-editable message M1, and are now associated to editable message M2. Also, a background highlight of the message, indicating that the message is editable, is moved from M1 to M2. From a point of view of all the recipients other than C2 who sent the message, message M2 appears in a central column that is used for all messages received from other participants, and from a point of view of recipient C2 who sent message M2, the message appears in the right column that used for messages sent by the respective recipient, aligned to a right side of the message thread 425.

Next, in the example shown, recipient C4 modified editable elements DEE1, DEE2, and thereafter sends edited message M3, that was based on editable message M2, to the recipients and the event initiator EI. The steps for editing and sending message M3 are analogous to the ones of editing and sending M2, steps S62, S72 and are therefore not separately shown in the flowchart of FIG. 1. Again, recipient C4 can remove some of the other recipients with button 422 but not event initiator EI. In the example shown, recipient C4 has changed the parameter of DEE1 to PAR3, and the parameter of DEE2 back to PAR1 as in the initial message M1. After C4 sends the message, edited message M3 is shown in the message thread 425 of all participants, and in message thread 325 of the EI as the third, last message of the thread, see FIGS. 3C and 4F. Messages M1 and M2 remains displayed with their respective settings, showing PAR1 and PAR1 for DEE1 and DEE2, respectively in M1, and PAR2 and PAR2 for DEE1 and DEE2, respectively in M2, but both messages cannot be edited anymore. Editable message M3 is shown below non-editable message M2 with a fixed, non-editable content CONT, and with displayed editable elements DEE1, DEE2 showing parameters PAR3, PAR1 that have been chosen by recipient C4, and the graphical elements ADD1, ADD2 to add additional parameters. Also, buttons 410, 421, 421 are removed or otherwise dissociated with non-editable message M2, and are now associated to editable message M3. Also, a background highlight of the message, indicating that the message is editable, is moved from M2 to M3.

As explained further below, in the example shown, event initiator EI sends a conformation message CM by accepting the editable message M3 as the final content or program for the event E, in a step S8EI and S9EI. Message CM will be received and displayed for all the participants in their message thread 425 with a label that indicates that the event program is final and not editable anymore, in steps S51, S52, SSN. No editable elements DEE1, DEE2 are displayed anymore on any of the messages M1, M2, and M3, and the message CM shows the full non-editable content of message CM accepted and chosen by the EI, in this case the last message sent M3. The message CM is aligned in the column from messages that were send from event initiator EI, in this case in the left column. Upon reception of the CM, confirmation buttons 427, 428, for example confirm/deny, yes/no buttons, can be displayed on the graphical user interface 400 of the recipients, where each recipient C that received the CM can accept or deny participation in the event, in an optional step S91, S92, S9N. The results of the final number of participants and participants denying to be present are sent in in a message or data packet to the EI, and the results can be analyze displayed in the dashboard 380 of EI, in a step SFEI.

Moreover, the graphical user interface 400 of the recipients C are configured such with each incoming message that is last displayed, starting with message M1 from EI, the editable elements EE1, EE2 are highlighted or otherwise displayed as displayed editable elements DEE1, DEE2 that can be edited, for example including at least one of the rate send button 432, rating scaling buttons RATE, select buttons SEL, editable text boxes ET, and that buttons or other user-operable elements are displayed associated to the last displayed message, including at least one of the send button 410, a button to remove participants 421, a button to add participants 422.

Also, additional graphical display features can be used to make the user interaction with the messaging thread 425 easy and fast, to make it fast and easy for the recipient to review editable elements EE of messages M with a short interaction time. For example, in the variant shown in FIGS. 4E, 4F, and 4G, at least the non-editable messages M are displayed having a message display area, i.e. a rectangular box, fixed display size. Moreover, at least in the non-editable messages M, the parameters PAR of the editable elements EE are displayed at the same or substantially the same location within the display area of the message M itself, even when the parameters PAR differ in length. This allows to present the same or very similar layout of the CONT and EE of each message for uniformity. For example, this can be done by placing and displaying the parameter or parameters of a specific editable element EE within a rectangular display box having a fixed size for all messages, and the rectangular display box is always at the same location relative to the display area or boundaries of the individual message itself, for each displayed message. The rectangular display box can be made visible or not, and serve as the highlighting of the EE. This allows the participants C to browse through the received messages of message thread 425 with high-speed, without the need to search for the relevant information of the editable elements in the non-editable messages.

Moreover, it is also possible that at least the non-editable messages have a limited size and/or data content, i.e. that the display area of a message is limited to a size that it fits within a screen of a terminal, or within the displayed area of a message thread 425, or preferably that at least two messages fit within a screen of the terminal, or within the displayed area of a message thread 425, such that one message or at least two messages can be instantaneously reviewed by the recipient without the need of scrolling. This allows to review at least two contributions of other participants or recipients C and event initiator at one glance to the display screen. These display features with respect to the messages M in message thread 425 allow to preserve a maximal display uniformity between the messages, so that the messages can be reviewed much faster as compared to message of variable sizes and layouts. The same can be done for the message thread 325 of event initiator EI.

In a case where the last displayed message M is automatically designated the editable message, each time a new message is received and displayed, in the example M2 and M3, the displayed editable elements DEE are displayed on the last incoming message, and removed from the penultimate or previous message. In this case, the participant can always modify and send the last message that is displayed, and facilitates to keep an overview of the changes by both EI and the participants. However, in a variant, it is also possible that a participant to the communication can choose any of messages M1, M2, M3 or other additional message if present, in the message thread, to make it the editable message, and to thereby highlight the selected message and show the displayed editable elements DEE. For example, in the message thread shown in FIG. 4F, it is possible that none of messages M1, M2, M3 are highlighted, and that the participant can freely choose which message he wants to edit and then send back to all participants and to the EI, for example by selecting the message by pressing the display area of the message for a certain time duration, or otherwise manually selecting it via the graphical user interface.

In the example show in FIG. 3C and 4F, recipient C4 modified the DEE1, DEE2 of the message M2 send by recipient C2, and sent it to the participants and the EI, displayed as edited message M3. For illustration purposes, the DEE1, DEE2, buttons 421, 422 and 410 are still shown associated to message M3 for modification by the participants, but as the confirmation message CM has already been received, they would be removed or otherwise disabled, such that no more message can be send in the message thread 425. Also, in a variant, it is possible to associate to each message that is displayed, whether editable or not, a rating button 423 that allows to rate the message as a whole. This allows for participants C1, C2, . . . , CN to vote for or rate a specific program of the event that is present in a message, without the need of making any modifications or edits to an editable message. The rating can be send to the EI for summation aggregation, and for display in dashboard 380 by a message or data packet, and in a variant, a rating value for each message can also be displayed in association with each message of message thread 425, to give a feedback to the participants C1, C2, . . . , CN.

As the present instant messaging method 200 can also be part of an already existing instant messaging software, methodology, and environment, it is possible that the at least one of the send button 410, the add and remove button 412, 422, the rating scale 423 are shown globally to the message thread 425 in the message editing toolbar 491 that is located below message thread 425, as exemplarily shown in FIG. 6. For example, a globally-displayed message editing toolbar 491 can include a message rating button 423 to rate a selected message, a recipient management button 497 for adding and removing or otherwise changing recipients, a message editing button 495 for initiating the editing of an already received message M, a send button 410 to send off an edited message. Also, once the editing has been requested by button 492, a text editor 491 can appear, so that editable text boxes ET1, ET2 can be edited. A mapping icon 499 can also be selected, so that any geographic location or neighborhood that is mentioned as a parameter in the DEE can be visualized with a mapping application. In this variant, the message to be edited is first chosen in the message thread 425, and can thereafter be edited with message editing toolbar 491. Also, it is possible that only the last message displayed can be edited. This allows to easier integrate the instant messaging method 200 into pre-existing messaging solutions. Also, to improve user convenience, it is possible to keep the symbols and placements of the icons the same or similar to the pre-existing environment.

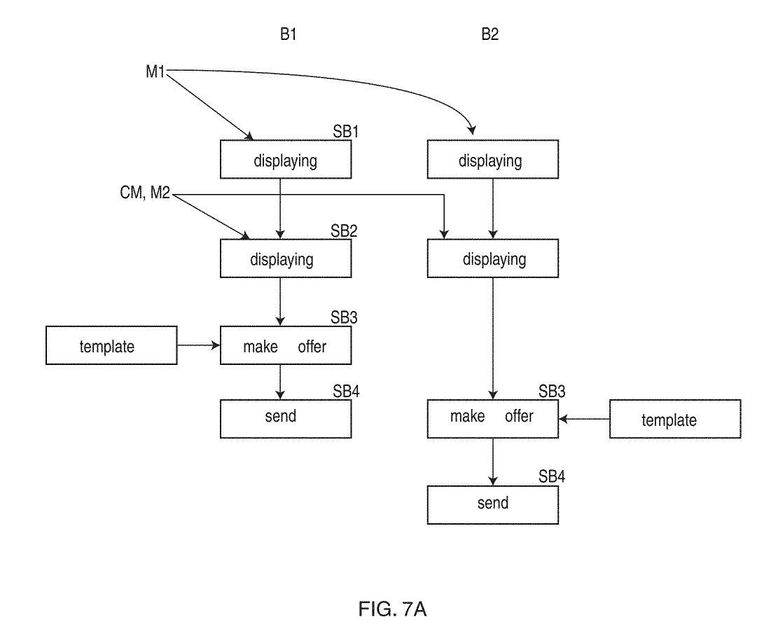

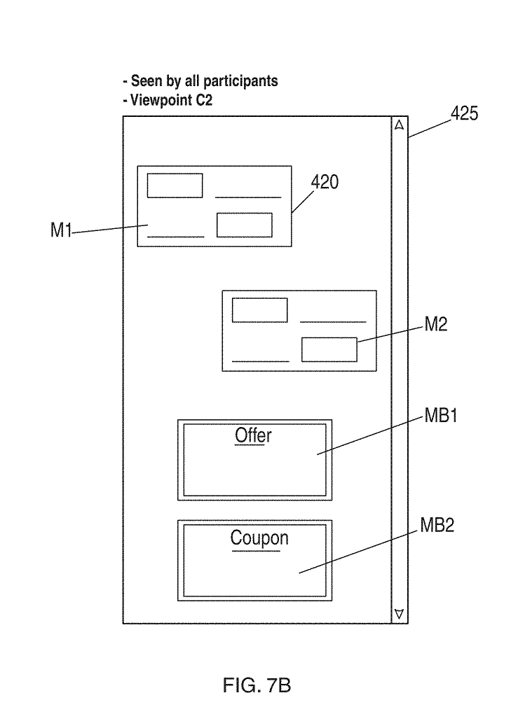

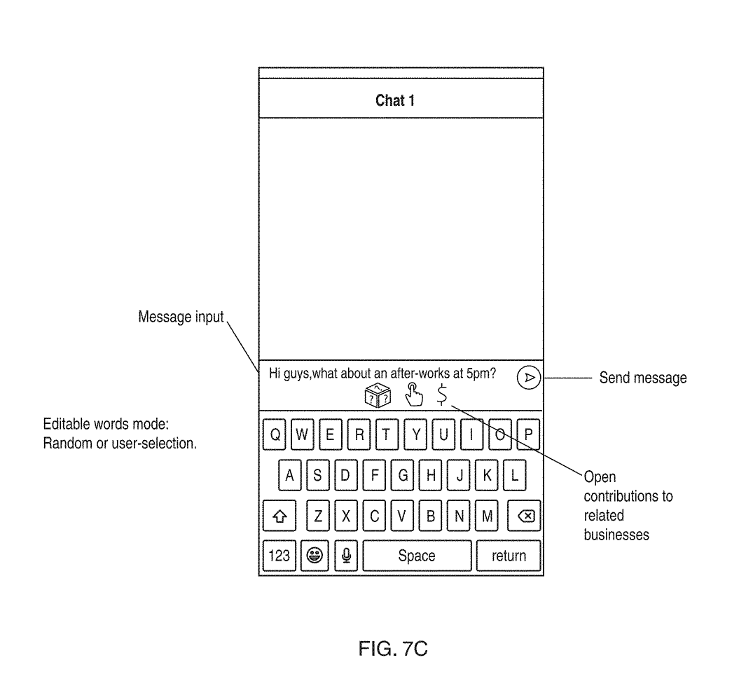

According to another aspect, the instant messaging method 200 can include third-party contributors or recipients, for example business contributors B1, . . . , BM as an additional class or category of recipients, that can interact with the recipients C1, . . . , CN, with a limited capacity, for example to observe the message thread 425 without being able to edit, or to make offers, deals, or proposals related to the event E, as exemplarily shown in the flowchart of FIG. 7A for two businesses B1, B2. M is a positive integer number, for example the number M of businesses identified in the parameters of an editable element EE of the first message M1. For example, business B1 to B4 that are identified as parameters PAR1 to PAR4, respectively as shown in DEE2 of FIG. 1G can be notified by a message that there is an interest in holding an event or organizing a gathering there. This can be done based on the identification of businesses as parameters PAR1 to PAR4 of the first message M1, or can be done once a confirmation message CM has been sent to the participants, for example identifying one chosen business, or a geographic area having several businesses, or a location that includes several businesses, for example but not limited to a business park, a food court, a neighborhood, a street, a shopping mall, a strip mall, a resort, a pedestrian zone, a point-of-interest POI. In a variant, it is also possible that the business B1, . . . BM, or another class of participants, only have viewing rights to the messages, and cannot respond or otherwise reply to the incoming messages M1, M2, etc. This can be used such that business will be notified of an event, for example upon the sending of the CM to the participants, for notification or reservation purposes only.

As shown in FIG. 7A, a first initiating message M1 can be received at different businesses, for example two (2) businesses B1, B2, that have been identified as parameters PAR in editable elements EE of the M1 sent by the EI. The identification of the businesses and their respective electronic address can happen by an automatic process, for example but not limited to a parser, word recognition algorithm, semantic analysis algorithm, pattern recognition algorithm for text, that finds business names in the content of M1, for example by activation of button 360 or automatically after message M1 has been sent, can be selected from a list of pre-stored businesses on the contact list of the terminal 10 of EI, from a contact list that is available through electronic data services, for example Yelp™, Google Maps, or other type of remote data services from the internet NET and server SERV. Next, the instant messaging software of the terminals 10 of the business B1, B2, display the content of the message M1 on their graphical user interface, in steps SB1. Thereafter, the businesses can review message M1 and see if they can make an offer, a reservation, or another type of business dealing related to the content of message M1. It is also possible that only one of the business B1, B2 receives the message CM once the final message CM has been sent, the business that has been identified as the destination or venue for the event, so that the message CM can serve to make a reservation, or can be used by the selected business to send a coupon or send a welcome message to the participants.

In a step SB3, one of the business can make a specific offer to the EI and the recipients C1, . . . CN. In the example shown, business B1 and B2 have made an offer based on the message M1, M2 at different times, respectively, in a step SB3. Next, these offer messages have been sent to the participants C1, . . . , CN and the EI. It is also possible that the business B1 uses a template to send the offer, for example an electronic version of a coupon MB2 with an identifier such as a barcode or matrix code, or has manually edited an offer MB1 for the EI and the recipients C1, . . . CN. Unlike the application software of the recipients, the application software of the businesses B1, . . . , BM running on their respective terminal can be such that it does not allow to modify and send any of the messages M1, M2, M3, or CM received, and can be configured to only show a viewable version of M1, M2. Their response message MB1, MB2 can be a commercial message that has been edited by themselves, for example via a template.

FIG. 7B shows the graphical user interface 400 from the point of view of the recipients C1, . . . , CN, in which businesses B1 and B2 were able to chime into the discussion and have sent an offer MB1 and a coupon MB2, respectively, after an initial message M1 and a modified message M2 have been sent to at least these two businesses B1, B2. These appears in a timely order in the message thread 425 of the recipients C. In a variant, the commercial messages MB1, MB2 can appear as a pop-up windows outside the message thread 425, or in a separate message thread.

In another aspect, the instant messaging method 100 is used by a travel company, for example an airline company, to get a customer feedback on a potential offer for potential and existing customers. In this example, the event initiator EI is a marketing or business development manager at the airline company, the event E is a purchase offer that the airline company wants to provide for one or more specific dates. Moreover, the recipients C1, . . . , CN are former, actual, and future customers from a customer database. EI sends out a first message M1 to a list of recipients, for example people that have signed up to the frequent flyer program, to ask for the most desired destination for a future week-end, for example the next week-end. The initial content CONT of the message M1 could be “A romantic weekend in Rome for less than 100 Euros. Let's take one hour to make the dream come true!” In this message M1, “Rome” is made an editable element EE1 with one parameter PAR1, modifiable by recipients to any of a list of cities that are directly flown to by the airline as a parameter restriction, and “100” is made an editable element with one parameter, but limited to a range between a first and a second monetary value. Next, recipients C1, . . . , CN start responding to the message M1 by edited messages M2, M3, M4, etc. and by ratings of the messages M1, M2, M3, M4, etc. The dashboard 380 of EI will show trends in destinations and price requests by participants, for example, trends and minima and maxima, as well as average and median value in the pricing that is requested, and trends of the most selected destination, and rankings of the most selected destination.

The message thread can be kept open for a certain time period, for example one hour or one business day, and thereafter, the EI, based on the quantity of feedback received via ratings by tracking the dashboard 380, or a time-out timer, can modify the last message to make a conformation message CM, reading “A romantic weekend in Biarritz for less than 60 Euros. Let's take one hour to make the dream come true!” The CM message is later followed up by more information, including a web link, for reserving the specific offer in the CM. The CM message can be also restricted to certain recipients C1, . . . , CN, for example those who selected or well-rated the final destination of the EE1, being “Biarritz.” For this purpose, the responses and ratings of the different recipients C1, . . . , CN can be tracked and stored to each customer profile of the recipients. With this example of the instant messaging method 200, it is possible to update electronic customer profiles, to increase airplane occupancy, with late or last-minute offers, to improve timetables for the flights, and destination scheduling. The data can be used for newsletters and to generate future customer-specific offers.

According to another aspect, the event E is a request for an offer for a commercial service, initiated by the event initiator EI in the role of a requestor, and the recipients are business that can potentially provide such service. For example, the EI is looking for a delivery service quote, and composes and sends the following initiation message M1: “Parcel 20 kg 20(w)×50(1)×30(h) to be delivered in CERN (Geneva) until June 30 for the cheapest price.” The underlined portions have been designated as editable element EE1, EE2, with one parameter PAR1 each, as a freely editable text ET option, with the remaining two portions being fixed content CONT1, CONT2. A first business C1 makes an offer by modifying the displayed editable elements DEE1, DEE2, and sending the following edited message M2: “Parcel 20 kg 20(w)×50(1)×30(h) to be delivered in CERN (Geneva) on June 25th for 50$.” Another business replies later by the message M3: “Parcel 20 kg 20(w)×50(1)×30(h) to be delivered in CERN (Geneva) on June 22nd for 60$.” Based on the messages M2, M3, the EI as then able to select the best price/time to delivery ratio that suited his needs or the needs of his customer.

According to yet another aspect, the event E is a homework assignment, the EI is a teacher, teaching assistant, or a professor, and the recipients C are the students of a specific class or lecture. For example, a French foreign language professor being the EL reaches out to all of his students C with a message M1 that reads as follows: “On se retrouve tous au café Flore qui est ouvert à 15 h, ” having four (4) editable elements EE1, EE2, EE3, and EE4. For each of the EE1 to EE1, the EI has made three different parameters, with EE1 having PAR1 as “retrouve”, PAR2 as “retrouvent”, PAR3 as “retrouves”, with EE2 having PAR1 as “au”, PAR2 as “à”, and PAR3 as “chez,” with EE3 having PAR1 as “est”, PAR2 as “ait”, PAR3 as “a”, and EE4 with PAR1 as “à”, PAR2 as “au”, and PAR3 as “ ” (empty box). This sentence in the message M1 can be presented to the students as a multiple-choice questions with graphical element SEL, where the students can select one of the three parameters of each EE to select a complete sentence, as shown in FIG. 4C with respect to SEL1, with no editable text boxes, nor any ratings. This allows to students to respond, and submit their response as a message M2, M3, etc. The teacher as EI can then grade them according to how they rated the solutions from the best to the worst. Parents could be involved in this application as recipients with no rights or access to modify the messages, only for viewing, as so-called viewing only participants, and having the requisite application software with no editing rights for the messages installed on their terminal.

Moreover, the proposed instant messaging method and instant messaging system can be implemented with a messaging server 31 and an application that is installed on the terminal 10, 20 of the participants. For example, system 100 can be split in an instant messaging software that is operable on a server 31 with access to telephony data networks 40, using a customized or existing data protocol that handles the communication and message exchange between the devices or terminals 10, 20, and in one or more applications, for example applications for the participants C, and in applications for the business participants B, or other types of participants, for example view-only participants. The user and business applications can be implemented to access local or remote databases, to store and manage various data related to the particular user or participant of the terminal 10, 20, for example preferences, user profile data, present and past location information.

Moreover, it possible that the local database of each terminal 10, 20 that is operating the instant messaging software, are synchronized with a global database of the system, in a two-way replication. The messaging server can filter the copies or replications of the local user databases to provide for specific data access rights, disallowed content, and privacy rules that are custom to each participant or user, or participant or user groups. This allows to centrally manage data right access rights for each one of the terminals of the participants via the instant messaging server. In the case of the terminals and applications of business participants, the instant messaging server can receive and extract relevant data to communicate to potential business participants out of a list or group of business participants. For example, the instant messaging server can be configured to automatically extract specific relevant information with respect to businesses from parameters PAR of editable elements EE and other content information from messages M, and then forward the messages to business that are related to this information. In this respect, the relevant information for businesses can include but is not limited to the total number of participants to the event, the time slot and date of the event, an activity related to the event, for example to parse the message to find keywords such as “dinner,” “lunch,” “skiing,” “soccer game,” “after-work,” “happy hour,” “amusement park,” “movies,” such that the related businesses can be notified, including bars, restaurants, ski resorts, transportation companies, or other business related to this activity.

In sum, according to some aspects, the proposed instant messaging method and system is a powerful alternative to Doodle™ or similar application to set up events and meetings. It allows faster, more friendly interaction with people with a maximal flexibility, by relying on an already existing messaging interface or program, or a messaging interface that is based on instant messaging technology. It also proposes an alternative to conventional chat and texting applications by providing direct content interaction, and limited or no access to content that is designated as only viewable by the event initiator. As the messages can be of limited size and displayable in messaging interface without the need for scrolling or zooming out, the initial message and the follow-up messages of the participants can be easily and rapidly reviewed, and the participant can directly modify one of the messages via the editable elements EE, for example by modifying the message that has been last received, being dedicated for editing, to change the parameters PAR to make his contribution, and sent his version of the message back to the other participants and the event initiator EI. It is also possible that no text editing is necessary on the message with the active editable elements, by the use of multiple-choice menus or pop-out selectable menus, so that the user can directly select his preferred option of the event, within the conventional messaging context.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A method for message communication to interactively determine parameters of an event, the method comprising the steps of:
displaying a first messaging user interface on a first terminal of an event initiator;
composing a first message by the event initiator by inputting a content with an input device of the first terminal, the content of the message related to the event;
selecting a portion of the content to be designated an editable element of the message, the selected portion of the content including a first parameter of the first message;
sending the first message to a first receiver;
displaying the first message in at a second messaging user interface on a second terminal of the first receiver, the selected portion of the first message being highlighted at the second messaging user interface;
modifying the editable element of the first message by the first receiver to change the selected portion to a second parameter to create a second message; and
sending the second message to the event initiator.

2. The method of claim 1, further comprising the steps of:
displaying the first and second message in a message thread at the first and second messaging user interface.

3. The method of claim 1, further comprising the steps of:
sending the message to a second receiver;
displaying the message at a third messaging user interface on a third terminal of the second receiver, the selected portion of the message being highlighted at the third messaging user interface;
returning the message by the second receiver to the event initiator without changing the editable element to accept the first parameter of the event.

4. The method of claim 1, further comprising the steps of:
displaying the second message at the first messaging user interface on the first terminal of the event initiator;
accepting the change of the selected portion from the first parameter to the second parameter by the first receiver by locking or removing the editable element of the second message, and sending an acknowledgement message to the first receiver.

5. The method of claim 4, further comprising the steps of:
sending the acknowledgement message to an organizer or host of the event for reservation.

6. The method of claim 1, further comprising the step of:
highlighting the selected portion of the message on the first messaging user interface, after the selecting.

7. The method of claim 1, wherein the editable element of the message includes at least one of a location for an event, a type of event, a geographic area for the event, a starting time for the event, a duration of the event, an activity proposed for the event, and a meal at the event, a beverage at the event.

8. The method of claim 1, wherein the step of selecting includes a step of automatically selecting the editable element by an automatic process by a semantic search algorithm.

9. A method for message communication between an event initiator and a plurality of participants to interactively determine parameters of an event, the method comprising a step of:
displaying a plurality of messages in a message thread of a graphical user interface of a terminal of a participant, the first message displayed in the message thread having been sent by the event initiator to the plurality of participants, each message of the plurality of messages includes and displays a content that is the same for all messages, the content related to the event, and each message includes and displays a parameter of a plurality of parameters that are associated to an editable element, each one of the plurality of parameters being different from each other; and
selecting one of the plurality of messages displayed in the message thread to become an editable message such that the participant of the terminal can edit the editable element to change the parameter that is displayed to a different parameter among the plurality of parameters.

10. The method for message communication according to claim 9, wherein the step of selecting is automatically performed by the terminal to choose the last message in the message thread, and the other messages other than the last message are not editable.

11. The method for message communication according to claim 9, wherein the step of selecting is performed by the participant of the terminal to manually choose one of the messages in the message thread, and upon choosing the one message, the other messages become non-editable.

12. The method for message communication according to claim 9, wherein a size of a display area of each one of the plurality of message is displayed such that one message fits into a screen of the terminal without the need for scrolling or zooming out.

13. The method for message communication according to claim 9, wherein a message of the plurality of message other than the first message is a message that has been sent by one of the other participants to the participant.

14. The method for message communication according to claim 9, wherein all the message other than the one message are displayed such that the content and the parameters cannot be modified by the participant.

15. A system for message communication between an event initiator and a plurality of potential participants to an event, to interactively determine parameters of the event, the system comprising:
a messaging server;
a terminal associated with the event initiator; and
a terminal associated to each one of the plurality of participants,
wherein the terminal of the event initiator is configured to,
display a first messaging user interface on a display of the terminal of the event initiator,
compose a first message by the event initiator by inputting a content with an input device of the terminal, the content of the message related to the event,
select a portion of the content to designate an editable element of the message, the selected portion of the content including a first parameter of the first message, and
send the first message to the plurality of participants, and
wherein a terminal associated to a participant is configured to, upon reception of the first message,
display the first message in a second messaging user interface on the terminal of the participant, the selected portion of the first message being highlighted at the second messaging user interface,
modify the editable element of the first message by the participant to change the selected portion to a second parameter to create a second message, and
send the second message to the event initiator and the other participants of the event.

16. The system of claim 15, wherein the terminal of the event initiator is configured to:
display the second message at the first messaging user interface on the terminal of the event initiator;
accept the change of the selected portion from the first parameter to the second parameter by the first receiver by locking or removing the editable element of the second message, and sending an acknowledgement message to the terminals of the plurality of participants.
